(19) United States
(12) Patent Application Publication
(10) Pub. No.: US 2010/0025133 A1
(43) Pub. Date: Feb. 4, 2010

(54) POWER SUPPLY SYSTEM

(76) Inventors: Kenichi Hamada, Hadano-shi (JP); Nobuyuki Kitamura, Minamitsuru-gun (JP)

Correspondence Address: OLIFF & BERRIDGE, PLC, P.O. BOX 320850, ALEXANDRIA, VA, 22320-4850, US

(21) Appl. No.: 12/449,548

(22) PCT Filed: Feb. 13, 2008
(86) PCT No.: PCT/JP2008/052327

§ 371 Date: Aug. 13, 2009

(30) Foreign Application Priority Data
Feb. 14, 2007 (JP) 2007-033034

(51) Int. Cl. B60K 1/00; H02P 27/00; B60L 15/02

(52) U.S. Cl. 180/65.31; 318/400.3; 307/10.1

(57) ABSTRACT

A power supply system is provided for supplying power to a first drive device and a second drive device functioning as a drive source of a moving body. A fuel cell and a storage battery device are connected via a power conversion device. The fuel cell can supply power to the first drive device and the storage battery device can supply power to the second drive device, respectively, without using the power conversion device. When an output request from the moving body is a normal output request, power is supplied to each of the drive devices by the fuel cell and the storage battery device, respectively. Only when power to be supplied to the first drive device as in the output request from the moving body is greater than an amount of power that can be generated by the fuel cell, that power supply from the storage battery device to the first drive device via the power conversion device is permitted. Thus, in a power supply device that is formed of a plurality of power supply devices connected via a power conversion device, it is possible to avoid, to the extent possible, decrease of efficiency of power supply to a drive device of a moving body.

### TECHNICAL FIELD OF THE INVENTION

The present invention relates to a power supply system for supplying power to a drive device of a moving body.

### BACKGROUND ART

Recently, fuel cells have become focus of attention as power sources having excellent operating efficiencies and environmental properties. Although a fuel cell outputs power in response to a request by controlling an amount of fuel gas supply, the output of power may sometimes have low responsiveness due to delay of response in the amount of gas supply. Accordingly, a combined use of battery and fuel cell has been proposed, where the fuel cell and the battery (storage battery device) are connected in parallel to configure a power source, and an output voltage of the fuel cell is converted via a DC-DC converter. In this regard, a technique has been disclosed that provides a moving body with a first drive motor directly driven by supply power from a fuel cell with no use of a DC-DC converter and a second drive motor directly driven by supply power from a battery with no use of the DC-DC converter, and controls power supply to each of the drive motors in response to an output request from the moving body (see Patent Document 1, for example).

Also disclosed is a power source system that is formed of a fuel cell and a battery connected via a DC-DC converter, for supplying power to drive a drive device of a moving body (see Patent Document 2, for example). In this power source system, it is possible to suppress power loss due to the DC-DC converter by connecting the drive motor to the power source system such that the motor can receive power supply directly from the fuel cell with no use of the DC-DC converter and setting the proportion of power supply from the fuel cell within a predetermined range.

### Patent Document 1: Japanese Unexamined Patent Publication No.

### Patent Document 2: Japanese Unexamined Patent Publication No.

### SUMMARY OF THE INVENTION

In the course of supplying power from a fuel cell to a drive device of a moving body, power supply to the drive device may sometimes be unstable because of reasons such as low responsiveness of fuel gas (for example, hydrogen, etc.) supply to the fuel cell. Thus, in order to more stabilize the power supply, a storage battery device such as a battery is sometimes employed in addition to the fuel cell. These power supply sources having different output characteristics are generally connected via a power conversion device such as a DC-DC converter.

With such a power supply system that is formed of a plurality of power supply devices connected via a power conversion device such as a DC-DC converter, it is possible to perform power supply to a drive device in a stable manner. However, depending on the way of power supply, some power loss may be produced in the course of supplying power from the power supply device to the drive device via the DC-DC converter and the like, and may possibly result in decrease of power supply efficiency of the power supply system.

The present invention is made in view of the aforementioned problems, and is purposed to avoid, to the extent possible, decrease of efficiency of power supply to a drive device of a moving body, in a power supply system that is formed of a plurality of power supply devices connected via a power conversion device such as a DC-DC converter.

In the present invention, in order to resolve the aforementioned problems, in a power supply system that is formed of two power supply devices, i.e. a fuel cell and a storage battery device, connected via a power conversion device such as a DC-DC converter, two drive devices are provided to a moving body so that each of the drive devices can receive supply power from each of the power supply devices with no use of the power conversion device, and as for the drive device that receives power supply directly from the fuel cell capable of power generation, restriction is made such that the drive device receives supply of power via the power conversion device only under a certain condition. In this way, it is possible to suppress power loss in the power conversion device to the extent possible.

More specifically, the present invention relates to a power supply system mounted on a moving body, for supplying power to a first drive device and a second drive device functioning as a drive source of the moving body, the power supply system including:

a power conversion device which converts an output characteristic of supply power from a power supply device;

a fuel cell as a power supply device, the fuel cell being capable of supplying power generated through electrochemical reaction between oxygen-containing oxidation gas and hydrogen-containing fuel gas to the first drive device without using the power conversion device;

a storage battery device as a power supply device, connected to the fuel cell via the power conversion device, the storage battery device being capable of storing electric power and of supplying the stored power to the second drive device without using the power conversion device; and

a power controller which controls power to be supplied from the fuel cell and the storage battery device to the first drive device and the second drive device according to an output request from the moving body, wherein

when the output request from the moving body is a normal output request, the power controller controls power supply such that power is supplied to the first drive device and the second drive device by the fuel cell and the storage battery device respectively, and

when power to be supplied to the first drive device as in the output request from the moving body is greater than an amount of power that can be generated by the fuel cell, the power controller permits power supply from the storage battery device to the first drive device via the power conversion device.

As mentioned above, the power supply system according to the present invention is mounted on the moving body, and performs power supply to the drive devices that are engaged in the moving the moving body. Note that the moving body is not limited to transportation means such as automobiles, trains, ships and the like, but also includes moving objects in general such as robots and the like.

There are two drive devices, i.e. the first drive device and the second drive device, for moving this moving body, and driving forces to be generated by the respective drive devices are determined as appropriate based on a situation the moving body is in, including, for example, load status and the like when the moving body is in motion or stopped. To these drive devices, power is supplied from the power supply system according to the present invention that includes the fuel cell and the storage battery device as the power supply devices.

In the power supply system according to the present invention, the fuel cell and the storage battery device, which are the power supply devices having different output characteristics, are connected to one another via the power conversion device. In this way, it is possible to perform power supply to each of the first and second drive devices in a stable manner. Here, the first drive device can receive power supply directly from the fuel cell with no use of the power conversion device, and the second drive device can receive power supply directly from the storage battery device with no use of the power conversion device. In other words, if trying to supply power from the storage battery device to the first drive device, or if trying to supply power from the fuel cell to the second drive device, then the supply power will inevitably go through the power conversion device. Although this power conversion device is for converting an output characteristic of power to be supplied from each of the power supply devices, some power may be consumed within the device during the conversion process and consequently, non-negligible power loss may be produced in the power to be supplied to the drive device.

In the power supply system according to the present invention, the power controller controls power supply between each of the power supply devices and each of the drive devices, so as to suppress power loss to be produced in the power conversion device to the extent possible. That is, when it is necessary to drive each of the drive devices in response to an output that is requested from the moving body based on a situation the moving body is in, such as move or stop of the moving body, the power controller controls power supply such that no power supply from each of the power supply devices to each of the drive devices via the power conversion device is performed except for cases under a certain condition.

When the output request from the moving body is a normal output request, power supply to the first drive device is from the fuel cell only and power supply to the second drive device is from the storage battery device only. Here, note that the normal output request is such a request from the moving body that outputs to be exerted by the first drive device and the second drive device as determined in response to the output request from the moving body can be achieved by the respective supply powers from the fuel cell and the storage battery device. Also note that the outputs to be exerted by the first drive device and the second drive device are determined by appropriately distributing the output request from the moving body such that the drive forces by the respective drive devices realize a required move or stop of the moving body. Also, the range of the normal output request may be varied in consideration of parameters having influence on output characteristics of the fuel cell and the storage battery device, including temperature and the like of each device, for example.

As such, when the output request from the moving body is a normal output request, it is possible to supply power from each of the power supply devices to each of the drive devices with no use of the power conversion device by appropriately determining drive forces to be exerted by the first drive device and the second drive device. The power controller thus makes a control to realize such power supply. In this way, as long as the output request from the moving body is a normal output request, it is possible to suppress power loss in the power conversion device to the extent possible.

On the other hand, when the output request from the moving body is not a normal output request and power to be supplied to the first drive device as in the output request from the moving body is greater than an amount of power that can be generated by the fuel cell, the power controller permits supply of power to the first drive device from the storage battery device in addition to from the fuel cell. Since the first drive device can receive power from the fuel cell, which has an appropriately adjustable output (supply power), without using the power conversion device, it can exert its drive power in an efficient and timely manner. Therefore, contribution of the first drive device to the driving of the moving body is considered to be greater than that of the second drive device, the drive force of which being restricted by an amount of power stored in the storage battery device. Thus, power supply to the first drive device should be maintained to the extent possible. Therefore, when power to be supplied to the first drive device as in the output request from the moving body is greater than an amount of power that can be generated by the fuel cell, power supply from the storage battery device to the first drive device via the power conversion device is permitted as an exceptional case. Alternatively, power supply via the power conversion device may also be permitted in other cases, such as when it is otherwise determined that power should be supplied to the first drive device, including in case of emergency and the like.

As such, in the power supply system according to the present invention, when each drive device is required to exert its drive force in response to an output request from the moving body, although those power supply routes not going through the power conversion device are to be maintained in principle, however, if power that is required for the first drive device is equal to or greater than an amount of power that can be generated by the fuel cell, then power supply via the power conversion device will be performed. In this way, it is possible to limit influence of power loss to be produced in the power conversion device while still satisfying the output request from the moving body, thereby avoiding decrease of power supply efficiency to the extent possible.

In order to avoid this decrease of power supply efficiency with more certainty, the power controller may be used to restrict power supply from the storage battery device to the first drive device via the power conversion device to cases only when power to be supplied to the first drive device as in the output request from the moving body is greater than an amount of power that can be generated by the fuel cell. That is, the flow of power supply via the power conversion device may be occurred in a more restricted manner.

In the above-mentioned power supply system, the normal output request is an output request within a range where the power to be supplied to the first drive device as in the output request from the moving body is less than or equal to an amount of power that can be generated by the fuel cell, and in such a case, the power controller may control power supply such that:

when the power to be supplied to the first drive device is less than or equal to an amount of power that can be generated by the fuel cell, power supply to the first drive device is performed by the fuel cell only and power supply to the second drive device is performed by the storage battery device only, and

when the power to be supplied to the first drive device is greater than an amount of power that can be generated by the fuel cell, power supply to the first drive device is performed by the fuel cell as well as by the storage battery device via the power conversion device.

That is, in the aforementioned power supply system, the judgment on whether the output request from the moving body is a normal output request or not is based on a criterion that the power to be supplied to the first drive device is less than or equal to, or greater than an amount of power that can be generated by the fuel cell. By having the power controller controlling power supply based on this criterion, it is possible to avoid decrease of power supply efficiency to the extent possible.

Also, in the power supply system described hereinabove, the power controller may make a control such that when the power to be supplied to the first drive device is greater than an amount of power that can be generated by the fuel cell, the deficiency of power, that is, the remaining of the power to be supplied to the first drive device after deduction of the maximum available power of the fuel cell, is supplied from the storage battery device to the first drive device. As such, when relying upon such power supply from the storage battery device via the power conversion device, it is possible to avoid decrease of power supply efficiency to the extent possible by minimizing the amount to be supplied in such manner.

And, in the power supply system described hereinabove, the storage battery device may store at least either one of power generated by the fuel cell and regenerative electric power generated by regeneration in at least one of the first drive device and the second drive device, and may use the stored power for power supply, and the power controller may determine power to be supplied to or supplied from the storage battery device according to a state of charge of the storage battery device, and may add the determined power to the power to be supplied to the first drive device, so as to control supply of power to be generated by the fuel cell.

The storage battery device is capable of cutting back the amount of energy necessary to drive the moving body, by storing power generated by the fuel cell, specifically the remaining of power generated beyond the amount to be supplied to the first drive device, and/or regenerative electric power generated during deceleration of each drive device, and then storing them in preparation for use in power supply thereafter. In this case, the amount of power stored in the storage battery device preferably belongs within a predetermined appropriate range (hereinafter referred to as “predetermined storage range”) from the standpoint of maintaining power supply capacity of the storage battery device, preventing deterioration of the device, and the like. Thus, the power controller according to the present invention controls supply power to be generated by the fuel cell in consideration of power necessary to maintain the amount of power stored in the storage battery device within the predetermined storage range (that is, power to be supplied to or discharged from the storage battery device) in addition to the power to be supplied to the first drive device as described hereinabove. In this way, it is possible to avoid decrease of power supply efficiency to the extent possible, while putting the drive force of the first drive device and the amount of power stored in the storage battery device in their respective preferable states.

The moving body for which power supply is performed by the power supply system described hereinabove may be a vehicle, and the first drive device may drive main drive wheels in the vehicle while the second drive device may drive drive wheels other than the main drive wheels. The main drive wheels are those primarily responsible for movement of the vehicle, and are corresponding to so-called front wheels of a FF vehicle and rear wheels of a FR vehicle. As such, by using the first drive device primarily for driving of the main drive wheels, it is possible to more preferably control movement of the vehicle. Additionally, even if the moving body is other than a vehicle, it is still preferable that the first drive device drive a mechanical component primarily responsible for movement of the moving body.

### BRIEF DESCRIPTION OF THE DRAWINGS

FIG. 1 is an illustration showing the schematic configuration of a vehicle on which a power supply system (fuel cell system) according to the present invention is mounted;

FIG. 2A is an illustration showing the former part of a first flowchart that relates to a power supply control process to be performed with respect to drive devices of the vehicle in the power supply system shown in FIG. 1;

FIG. 2B is an illustration showing the subsequent part of the first flowchart that relates to the power supply control process to be performed with respect to the drive devices of the vehicle in the power supply system shown in FIG. 1;

FIG. 3A is an illustration showing the former part of a second flowchart that relates to a power supply control process to be performed with respect to drive devices of the vehicle in the power supply system shown in FIG. 1;

FIG. 3B is an illustration showing the subsequent part of the second flowchart that relates to the power supply control process to be performed with respect to the drive devices of the vehicle in the power supply system shown in FIG. 1; and

FIG. 4 is an illustration showing a correlation between state of charge (SOC) and charge-discharge load Pbt3 in a battery provided in the power supply system according to the present invention, where the charge-discharge load is a quantified representation of a degree of charge/discharge to be performed for the battery.

### BEST MODE FOR EMBODYING THE INVENTION

A mode for embodying a power supply system according to the present invention will now be described in detail based on the drawings. The power supply system according to the present mode is a fuel cell system that is composed of a fuel cell 300 and a battery 400, for supplying power to drive motors which are corresponding to drive devices of an automobile (vehicle) 100 which is corresponding to a moving body according to the present invention.

### First Embodiment

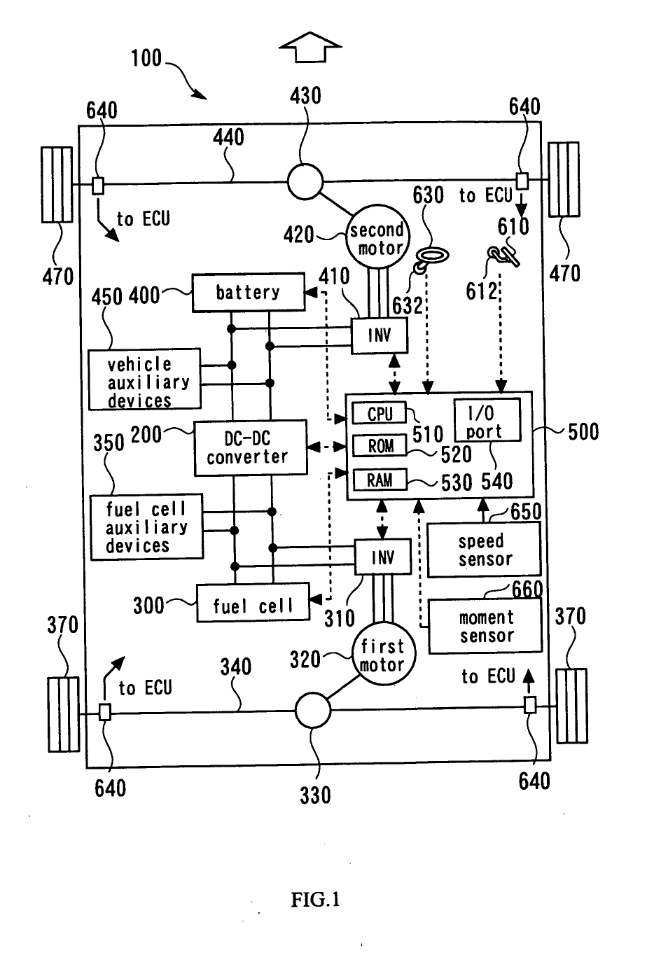

FIG. 1 is an illustration schematically showing the configuration of the vehicle 100 as a first embodiment of the present invention. This vehicle 100 includes: the fuel cell 300 that generates power through electrochemical reaction between hydrogen and oxygen; the battery 400 as a rechargeable storage battery device; and a DC-DC converter 200 as a power conversion device. The fuel cell 300 and the battery 400 are connected to one another via the DC-DC converter 200. The DC-DC converter 200 is a bi-directional DC-DC converter that converts a voltage input from the fuel cell 300 or the battery 400 into a target voltage and then outputs the same. A proton-exchange membrane fuel cell is used as the fuel cell 300, for example; whereas a lead storage battery or a nickel-hydrogen storage battery is used as the battery 400, for example.

A first motor 320 as a drive device of the vehicle 100 is connected to power source wirings between the fuel cell 300 and the DC-DC converter 200, via an inverter 310. Similarly, a second motor 420 as a drive device of the vehicle 100 is connected to power source wirings between the battery 400 and the DC-DC converter 200, via an inverter 410. Both the first motor 320 and the second motor 420 are three-phase synchronous motors having regeneration functionalities. An output shaft of the first motor 320 is connected to a rear wheel drive shaft 340 via a differential gear 330, so that the rear wheel drive shaft 340 and rear wheels 370 connected thereto are driven by rotation of the output shaft of the first motor 320. On the other hand, an output shaft of the second motor 420 is connected to a front wheel drive shaft 440 via a differential gear 430, so that the front wheel drive shaft 440 and front wheels 470 connected thereto are driven by rotation of the output shaft of the second motor 420. The inverters 310, 410 convert direct-current powers output from the fuel cell 300 and the battery 400 into three-phase alternating-current powers and supply them to the first motor 320 and the second motor 420, respectively.

Further, fuel cell auxiliary devices 350 such as a reformer and an air compressor, for example, are also connected to the power source wirings between the fuel cell 300 and the DC-DC converter 200. The fuel cell auxiliary devices 350 are devices that are used to supply hydrogen-containing fuel gas and oxygen-containing air required for generation of power in the fuel cell 300 to the fuel cell 300, and obtain their operating powers from the power source wirings connected thereto. Further, vehicle auxiliary devices 450 such as a lighting equipment and an audio equipment, for example, are also connected to the power source wirings between the battery 400 and the DC-DC converter 200, and obtain their respective operating powers from the power source wirings connected thereto.

The vehicle 100 further includes an ECU 500. The ECU 500 has a CPU 510, a ROM 520, a RAM 530, and an I/O port 540. Sensors provided at respective parts of the vehicle 100 are electrically connected to the ECU 500, and each of detection signals detected at the parts is input into the ECU 500 via the I/O port 540. The ECU 500 controls power supply from the fuel cell 300 and the battery 400 to each of the motors based on these detection signals.

Examples of the sensors provided at the respective parts of the vehicle 100 and electrically connected to the ECU 500 include, for example, an accelerator opening sensor 612 for detecting a degree of accelerator opening resulting from pressing on a gas pedal 610; a steering angle sensor 632 for detecting a steering angle of a steering 630; drive shaft sensors 640 for detecting revolutions per minute of the rear wheel drive shaft 340 and the front wheel drive shaft 440; a speed sensor 650 for detecting a vehicle speed; a moment sensor 660 for detecting a rotational moment of the vehicle; a temperature sensor and a voltimeter not shown for detecting an operating state of the fuel cell 300; and a charging capacity sensor and a voltimeter not shown for detecting a state of charge of the battery 400. Additionally, power supply from the fuel cell 300 and the battery 400 to each of the motors is controlled by the ECU 500, for example, by using the CPU 510 to read an operation control program stored in the ROM 520 onto the RAM 530 and then execute the same.

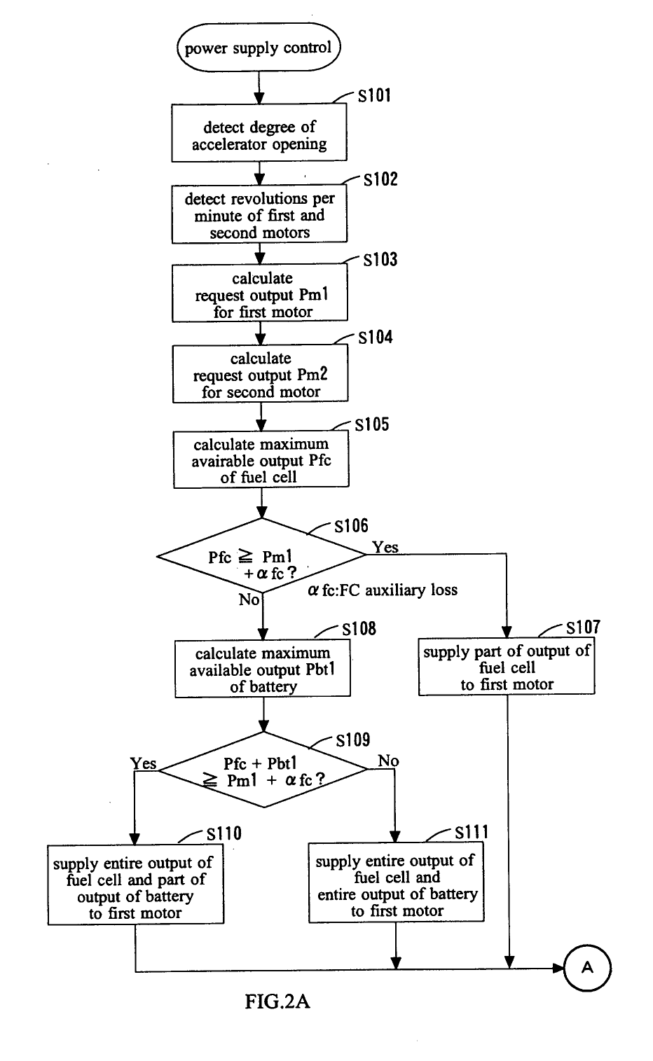

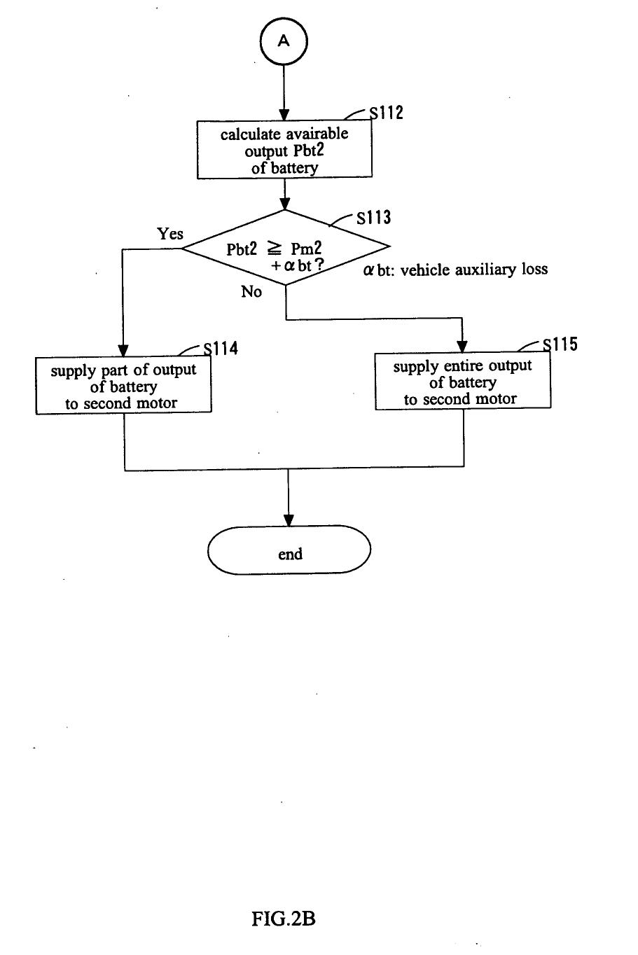

In the vehicle 100 thus configured, power supply to the drive devices i.e. the first motor 320 and the second motor 420 is performed by the fuel cell 300 and the battery 400. Since the fuel cell 300 and the battery 400 are connected via the DC-DC converter 200, it is possible to supply power from either one of the fuel cell 300 and the battery 400 to either one of the motors 320, 420. However, if trying to supply power from the fuel cell 300 to the second motor 420 or from the battery 400 to the first motor 320, then power supply will be performed via the DC-DC converter 200, which may produce power loss in the DC-DC converter 200 and result in decreased power supply efficiency. To this end, now described based on FIG. 2A and FIG. 2B is an embodiment of a power supply control process that can avoid, to the extent possible, decrease of efficiency of power supply to the first motor 320 and the second motor 420 in the vehicle 100 shown in FIG. 1. Note that FIG. 2A and FIG. 2B show a flow of the power supply control process separately in two parts because of space limitations.

First, in S101, a degree of accelerator opening of the vehicle 100 in a moving state (including a stopped state) is detected by a detection signal from the accelerator opening sensor 612. This accelerator opening is a parameter that relates to a running performance (speed and the like) of the vehicle 100 requested by a user driving the vehicle 100. Once the operation of S101 is complete, the process proceeds to S102. In S102, revolutions per minute (revolution speed) of the first motor 320 and the second motor 420 at the present moment are detected. The revolutions per minute of each motor is detected or calculated based on an output from a rotary encoder provided at each motor and/or detection signals from the drive shaft sensor 640 and the speed sensor 650.

In addition, as operations other than those in the aforementioned S101, S102, a steering angle of the steering 630 is detected via the steering angle sensor 632 and a rotational moment of the vehicle 100 is detected via the moment sensor 660. These operations are performed in order to ascertain the moving state of the vehicle 100 at the present moment. Once these operations are complete, operations of S103, S104 are performed.

In order to attain the running performance requested by the user of the vehicle 100 based on the moving state of the vehicle 100 detected by the operations in S101, S102 and the other operations described above, outputs to be exerted by the first motor 320 and the second motor 420 at the present moment are calculated, that is, an output to be requested to the first motor 320, or Pm1, is calculated in S103 and an output to be requested to the second motor 420, or Pm2, is calculated in S104. Note that the vehicle 100 according to the present embodiment is a vehicle having front wheels driven by the second motor 420 and rear wheels driven by the first motor 320, and thus is capable of four-wheel drive at the maximum. Note that although the first motor 320 has a maximum instantaneous output comparable to that of the second motor 420, a rated continuous output of the first motor 320 is higher than that of the second motor 420, so that the first motor 320 can afford a longer period of high output drive. Therefore, in the vehicle 100, the rear wheels are main drive wheels, and it is the fuel cell 300 that is positioned to supply power directly to the first motor 320, which is for driving the main drive wheels, without using the DC-DC converter 200.

Note that the request outputs Pm1, Pm2 for the first motor 320 and the second motor 420 are calculated based on the detected degree of accelerator opening and the detected revolutions per minute of each motor, as well as the running performance as requested by the user, running stability of the vehicle 100, and the like, in consideration of parameters indicating the moving state of the vehicle 100 such as the steering angle of the steering 630, the rotational moment of the vehicle 100, and the like. For example, if speed up is requested by the user, then the vehicle 100 tries to speed up by increasing the output of each motor. Since the running stability of the vehicle 100 may possibly be decreased when the steering angle of the steering 630 is larger than a predetermined angle, the request output for each motor is determined such that the drive force for the rear wheels of the vehicle 100 can be balanced with that for the front wheels. Note that the request output for each motor is calculated in consideration of the fact that the first motor 320 is the motor for driving the main drive wheels as described above. Once the operation of S104 is complete, the process proceeds to S105.

In S105, a maximum output available by the fuel cell 300 at the present moment, or Pfc, is calculated. This maximum available output Pfc is determined on the assumption that a maximum amount of hydrogen has been supplied to the fuel cell 300, and in consideration of parameters having influence on the current output such as cell temperature of the fuel cell 300, for example. Once the operation of S105 is complete, the process proceeds to S106.

In S106, a judgment is made on whether or not the maximum available output Pfc of the fuel cell 300 calculated in S105 is equal to or greater than a sum of the request output Pm1 for the first motor 320 and a FC auxiliary loss αfc i.e. an output required to drive the fuel cell auxiliary devices 350. The output sum is a sum of the outputs required to drive the devices and the like electrically arranged on the fuel cell 300 side with respect to the DC-DC converter 200 as a reference (in other words, the devices and the like not electrically arranged on the battery 400 side), as is also clear from FIG. 1. Therefore, the judgment in S106 can be said as judging whether or not power can be supplied from the fuel cell 300 to the first motor 320 and the fuel cell auxiliary devices 350 with no use of the DC-DC converter 200. The process proceeds to S107 if an affirmative judgment is made in S106 and to S108 if a negative judgment is made in S106.

The affirmative judgment in S106 represents it is possible to supply power from the fuel cell 300 to the first motor 320 and the fuel cell auxiliary devices 350 (hereinafter simply referred to as “first motor and the like”) without using the DC-DC converter 200. Thus, in S107, a part of the maximum available output Pfc of the fuel cell 300 is supplied to the first motor 320 and the like. At this time, since the supply power is supplied to the first motor 320 and the like with no use of the DC-DC converter 200, there would be no power loss to be produced in the DC-DC converter 200. Also, in this case of affirmative judgment, consequently power supply from the battery 400 to the first motor 320 and the like is prohibited because of the operation in S107. Thus, there would be no power supply to be performed via the DC-DC converter 200.

The negative judgment in S106 represents it is not possible to supply sufficient power from the fuel cell 300 to the first motor 320 and the fuel cell auxiliary devices 350 without using the DC-DC converter 200. Thus, in operations at S108 and afterwards (S108 through S111), power supply from the battery 400 to the first motor 320 and the like is considered. In S108, a maximum available output Pbt1 of the battery 400 at the present moment is calculated. This maximum available output Pbt1 is calculated on the assumption that the battery 400 discharges the entire amount of power it stores at the present moment, and in consideration of parameters having influence on the current output such as temperature of the battery 400, for example. Once the operation of S108 is complete, the process proceeds to S109.

In step 109, a judgment is made on whether or not a sum of the aforementioned maximum available output Pfc and the maximum available output Pbt1 of the battery 400 calculated in S108 is equal to or greater than the aforementioned sum of the request output Pm1 and the FC auxiliary loss αfc. In other words, the judgment in S109 judges whether or not the output request for the first motor 320 and the like can be satisfied by power supply from the fuel cell 300 with no use of the DC-DC converter 200 and power supply from the battery 400 via the DC-DC converter 200. The process proceeds to S110 if an affirmative judgment is made in S109 and to S111 if a negative judgment is made in S109.

The affirmative judgment in S109 represents it is possible to satisfy the output request for the first motor 320 and the like. Thus, in S110, the maximum available output Pfc of the fuel cell 300 at the present moment is entirely supplied to the first motor 320 and the like, with the deficiency of which being covered by the power stored in the battery 400. Therefore, it is possible to minimize power to be supplied via the DC-DC converter 200 and thereby suppress power loss in the DC-DC converter 200 to the extent possible.

On the other hand, the negative judgment in S109 represents it is possible to satisfy the output request for the first motor 320 and the like. Thus, in S111, the respective maximum available outputs of the fuel cell 300 and the battery 400 are entirely supplied to the first motor 320 and the like. At this time, in order to maximize generation of power in the fuel cell 300, it is preferable that the power from the fuel cell 300 and the like is preferentially supplied to the fuel cell auxiliary devices 350, with the remaining power being supplied to the first motor 320. In this case, there is a possibility that the first motor 320 cannot exert its output sufficiently.

Once either one of S107, S110, and S111 is complete, the process proceeds to S112. In S112, an available output Pbt2 of the battery 400 at the present moment is calculated. This available output Pbt2 is calculated on the assumption that the battery 400 has discharged the entire amount of power it stores as a result of the operations in S107, S110, or S111, and in consideration of parameters having influence on the current output such as temperature of the battery 400, for example. For example, in S112 following S107, since the battery 400 was not discharged in S107, the power that was stored in the battery 400 at the time the present control process began will be calculated as the available output Pbt2. In S112 following S110, since the battery 400 was discharged in S110, the power that remained stored in the battery 400 after the discharge will be the calculated as the available output Pbt2. In S112 following S111, since the battery 400 was entirely discharged in S111, the available output Pbt2 will be zero. Once the operation of S112 is complete, the process proceeds to S113.

In S113, a judgment is made on whether or not the available output Pbt2 of the battery 400 calculated in S112 is equal to or greater than a sum of the request output Pm2 for the second motor 420 and a vehicle auxiliary loss αbt i.e. an output required to drive the vehicle auxiliary devices 450. This output sum is a sum of the outputs required to drive the devices and the like electrically arranged on the battery 400 side with respect to the DC-DC converter 200 as a reference (in other words, the devices and the like not electrically arranged on the fuel cell 300 side), as is also clear from FIG. 1. Therefore, the judgment in S113 can be said as judging whether or not power can be supplied from the battery 400 to the second motor 420 and the vehicle auxiliary devices 450 with no use of the DC-DC converter 200. The process proceeds to S114 if an affirmative judgment is made in S113 and to S115 if a negative judgment is made in S113.

The affirmative judgment in S113 represents it is possible to supply power from the battery 400 to the second motor 420 and the vehicle auxiliary devices 450 (hereinafter simply referred to as “second motor and the like”) without using the DC-DC converter 200. Thus, in S114, a part of the available output Pbt2 of the battery 400 is supplied to the second motor 420 and the like. At this time, since the supply power is supplied to the second motor 420 and the like with no use of the DC-DC converter 200, there would be no power loss to be produced in the DC-DC converter 200. Also, in this case of affirmative judgment, consequently power supply from the fuel cell 300 to the second motor 420 and the like is prohibited because of the operation in S114. Thus, there would be no power supply to be performed via the DC-DC converter 200.

The negative judgment in S113 represents it is not possible to supply sufficient power from the battery 400 to the second motor 420 and the vehicle auxiliary devices 450 without using the DC-DC converter 200. In this case, the entire available output Pbt2 of the battery 400 is supplied to the second motor 420 and the like in S115. At this time, in order for the second motor 420 to exert its output to the maximum extent, it is preferable that the power from the battery 400 is preferentially supplied to the second motor 200, with the remaining power being supplied to the vehicle auxiliary devices 450. In this case, there is a possibility that the vehicle auxiliary devices 450 cannot be driven sufficiently. Once the operation of S114 or S115 is complete, the present control process ends.

According to the present control process, supply of power via the DC-DC converter 200 is prohibited when the first motor 320 and the like and the second motor 420 and the like are sufficiently driven by respective supply powers from the fuel cell 300 and the battery 400. On the other hand, with respect to the first motor 320 for driving the rear wheels or the main drive wheels of the vehicle 10, only when the fuel cell 300 cannot provide sufficient power necessary to drive the first motor 320, that power supply from the battery 400 to the first motor 320 via the DC-DC converter 200 is permitted. As such, by restricting execution of power supply via the DC-DC converter 200 to only under a predetermined condition, it is possible to suppress power loss in the DC-DC converter 200 and thereby avoid decrease of efficiency of power supply to each motor and the like to the extent possible.

### Second Embodiment

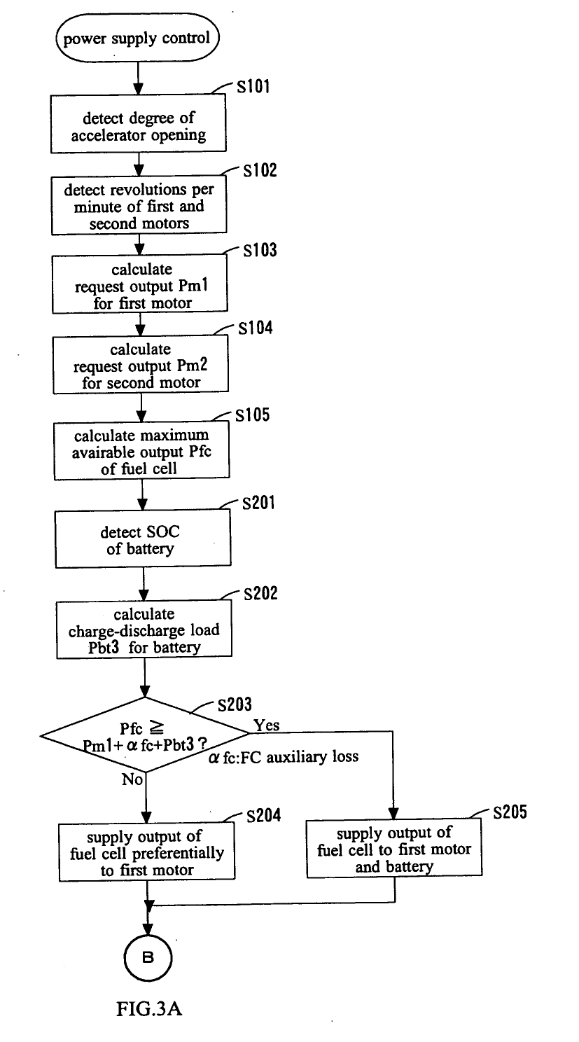

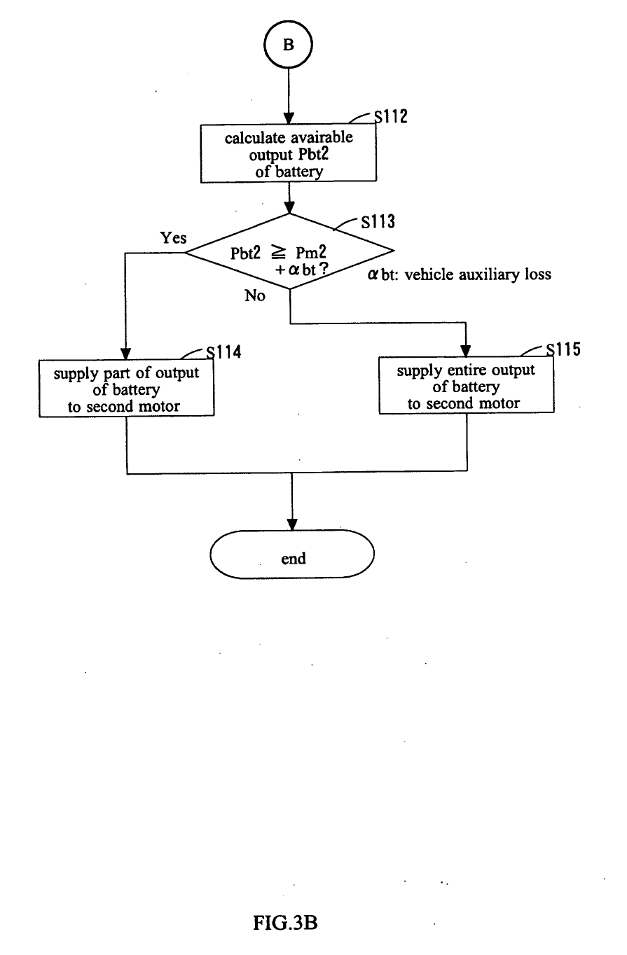

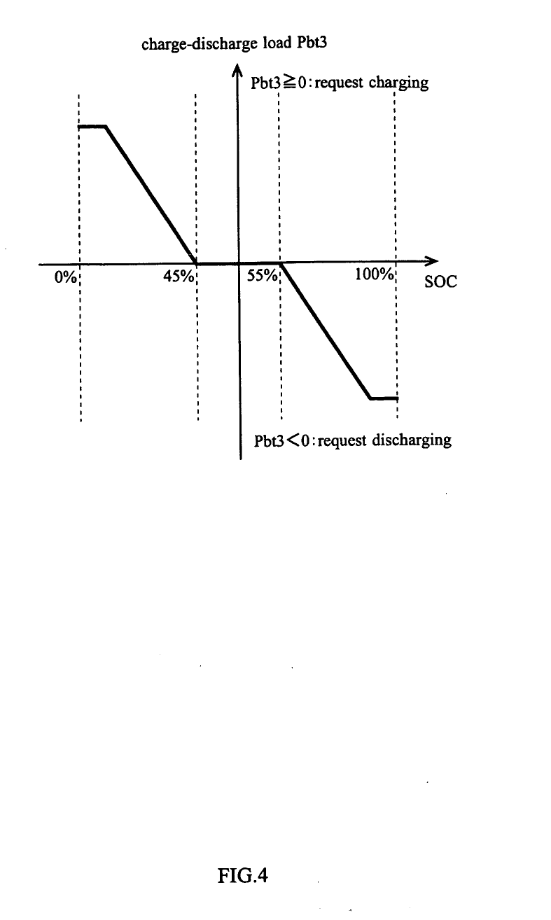

Now described based on FIGS. 3A, 3B, and 4 is another embodiment of a power supply control process that can avoid, to the extent possible, decrease of efficiency of power supply to the first motor 320 and the second motor 420 in the vehicle 100 shown in FIG. 1. Similar to FIGS. 2A and 2B, FIGS. 3A and 3B also show a flow of the power supply control separately in two parts because of space limitations. FIG. 4 is an illustration showing a correlation between state of charge (SOC) and charge-discharge load Pbt3 in the battery 400, where the charge-discharge load is a quantified representation of a degree of charge/discharge to be performed for the battery 400.

Among operations in the power supply control process shown in FIGS. 3A, 3B, those operations identical to those in the power supply control process shown in FIGS. 2A, 2B are indicated by the same reference numbers and thus are not described in detail. In the power supply control process according to the present embodiment, an operation of S201 follows the operation of step 105. In S201, a state of charge of the battery 400 is detected by SOC. In the battery 400, an output by the battery 400 at the present moment is calculated based on this SOC, where an output voltage under the full-charged state corresponds to SOC of 100% and an output voltage when the amount of power stored is zero corresponds to SOC of 0%. Once the operation of step 201 is complete, the process proceeds to S202.

In S202, a charge-discharge load Pbt3 for the battery 400 is calculated based on SOC of the battery 400 calculated in S201. Specifically, a map that represents the correlation between SOC and charge-discharge load Pbt3 shown in FIG. 4 is stored in the ECU 500, and the operation of S202 is executed by accessing this map. As shown in FIG. 4, the correlation between SOC and charge-discharge load Pbt3 shows a charge-discharge load Pbt3 of zero when SOC is in the range from 45% to 55% (hereinafter referred to as “appropriate SOC range”). This means that the battery 400 is in a most preferable charging state and thus requires neither charging nor discharging when SOC is within this range, from the standpoint of maintaining output characteristic of the battery 400, preventing deterioration of the battery 400, and the like. On the other hand, if SOC is less than or equal to 45%, then it means that the battery 400 has a small amount of power stored, which results in a positive value of charge-discharge load Pbt3 and thus requires charging of the battery 400. Additionally, the larger the charge-discharge load Pbt3, the more the necessary amount to charge. If SOC is equal to or greater than 55%, then it means that the battery 400 has a large amount of power stored, which results in a negative value of charge-discharge load Pbt3 and thus requires discharging of the battery 400. The smaller the charge-discharge load Pbt3, the more the necessary amount to discharge. Once the operation of S202 is complete, the process proceeds to S203.

In S203, a judgment is made on whether or not the maximum available output Pfc of the fuel cell 300 calculated in S105 is equal to or greater than a sum of the request output Pm1 for the first motor 320, the FC auxiliary loss αfc i.e. an output required to drive the fuel cell auxiliary devices 350, and the charge-discharge load Pbt3 calculated in S202. As described in the first embodiment, the output sum is a sum of the outputs required to drive the devices and the like electrically arranged on the fuel cell 300 side with respect to the DC-DC converter 200 as a reference and the output necessary to maintain SOC of the battery 400 within the appropriate SOC range. Therefore, the judgment in S203 can be said as judging whether or not power can be supplied from the fuel cell 300 to the first motor 320 and the fuel cell auxiliary devices 350 with no use of the DC-DC converter 200, while maintaining the battery 400 in an appropriate charging state through generation of power by the fuel cell 300. The process proceeds to S204 if an affirmative judgment is made in S203 and to S205 if a negative judgment is made in S203.

The affirmative judgment in S203 represents it is possible to supply power from the fuel cell 300 to the first motor 320 and the fuel cell auxiliary devices 350 without using the DC-DC converter 200, while putting the charging state of the fuel cell 400 in an appropriate state. Thus, in S204, power generated in the fuel cell 300 is supplied to the first motor 320 and the like, while performing charging or discharging of the battery 400. That is, power is supplied from the fuel cell 300 to the battery 400 if the charge-discharge load Pbt3 is a positive value; whereas power is discharged from the battery 400 and is supplied to the first motor 320 and the like if the charge-discharge load Pbt3 is a negative value. Thus, it is possible to perform power supply to the first motor 320 and the like with no use of the DC-DC converter 200, while maintaining the charging state of the battery 400 in an appropriate state.

The negative judgment in S203 represents it is not possible to provide sufficient power from the fuel cell 300 to the first motor 320 and the fuel cell auxiliary devices 350 without using the DC-DC converter 200 at the same time as putting the charging state of the fuel cell 400 in an appropriate state. Thus, in S205, power generated by the fuel cell 300 is preferentially supplied to the first motor 320 and the like, and if the charge-discharge load Pbt3 is a positive value, then the remaining power is supplied to the battery 400. Note that if the charge-discharge load Pbt3 is a negative value, then power discharged from the battery 400 may be supplied to the first motor 320 and the like.

Once the operation of S204 or S205 is complete, the process proceeds to S112. In S112, an available output Pbt2 of the battery 400 is calculated, as described above. However, since SOC of the battery 400 certainly belongs within the appropriate SOC range in S112 following the operation of S204, it is possible to perform power supply by the battery 400 in a stable manner.

According to the present control process, by restricting the execution of power supply via the DC-DC converter 200 to only under a predetermined condition, it is possible to suppress power loss in the DC-DC converter 200 and thereby avoid decrease of efficiency of power supply to the each motor and the like to the extent possible, as in the first embodiment. Furthermore, it is also possible to maintain the charging state of the battery 400 in an appropriate state to the extent possible.

### INDUSTRIAL APPLICABILITY

As above, according to a power supply system of the present invention that is formed of a plurality of power supply devices connected via a power conversion device such as a DC-DC converter, it is possible to avoid, to the extent possible, decrease of efficiency of power supply to a drive device of a moving body.

1. A power supply system mounted on a moving body, for supplying power to a first drive device and a second drive device functioning as a drive source of the moving body, the power supply system comprising:
a power conversion device which converts an output characteristic of supply power from a power supply device;
a fuel cell as a power supply device, the fuel cell being capable of supplying power generated through electrochemical reaction between oxygen-containing oxidation gas and hydrogen-containing fuel gas to the first drive device without using the power conversion device;
a storage battery device as a power supply device, connected to the fuel cell via the power conversion device, the storage battery device being capable of storing electric power and of supplying the stored power to the second drive device without using the power conversion device; and
a power controller which controls power to be supplied from the fuel cell and the storage battery device to the first drive device and the second drive device in response to an output request from the moving body, wherein
when the output request from the moving body is a normal output request, the power controller controls power supply such that power is supplied to the first drive device and the second drive device by the fuel cell and the storage battery device respectively, and
when power to be supplied to the first drive device as in the output request from the moving body is greater than an amount of power that can be generated by the fuel cell, the power controller permits power supply from the storage battery device to the first drive device via the power conversion device.

2. A power supply system in accordance with claim 1, wherein the normal output request is an output request within a range where the power to be supplied to the first drive device as in the output request from the moving body is less than or equal to an amount of power that can be generated by the fuel cell, and
the power controller controls power supply such that:
when the power to be supplied to the first drive device is less than or equal to an amount of power that can be generated by the fuel cell, power supply to the first drive device is performed by the fuel cell only and power supply to the second drive device is performed by the storage battery device only, and
when the power to be supplied to the first drive device is greater than an amount of power that can be generated by the fuel cell, power supply to the first drive device is performed by the fuel cell as well as by the storage battery device via the power conversion device.

3. A power supply system in accordance with claim 1, wherein the power controller makes a control such that when the power to be supplied to the first drive device is greater than an amount of power that can be generated by the fuel cell, the deficiency of power, that is, the remaining of the power to be supplied to the first drive device after deduction of the maximum available power of the fuel cell, is supplied from the storage battery device to the first drive device.

4. A power supply system in accordance with claim 1, wherein the storage battery device stores at least either one of power generated by the fuel cell and regenerative electric power generated by regeneration in at least one of the first drive device and the second drive device, and use the stored power for power supply, and
the power controller determines power to be supplied to or supplied from the storage battery device according to a state of charge of the storage battery device, and add the determined power to the power to be supplied to the first drive device, so as to control supply of power to be generated by the fuel cell.

5. A power supply system in accordance with claim 1, wherein the moving body is a vehicle,
the first drive device drives main drive wheels in the vehicle, and
the second drive device drives drive wheels other than the main drive wheels in the vehicle.
